(19) United States
(12) Patent Application Publication
(10) Pub. No.: US 2006/0170648 A1
(43) Pub. Date: Aug. 3, 2006

(54) Electrophoretic or bi-stable display device and driving method therefor

(75) Inventors: Guofu Zhou, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V., Eindhoven (NL)

(21) Appl. No.: 10/564,539

(22) PCT Filed: Jul. 8, 2004
(86) PCT No.: PCT/IB04/51168

§ 371 Date: Jan. 12, 2006

(30) Foreign Application Priority Data
Jul. 17, 2003 (EP) 031022122

(51) Int. Cl. G09G 3/34

(52) U.S. Cl. 345/107

(57) ABSTRACT

A drive circuit for a bi-stable display comprises: a driver (101, 102) which supplies drive waveforms (DWk) to the pixels (Pij) of the display during an image update period (IUk) wherein the image presented by the pixels (Pij) is updated. A controller (103) controls the driver (101, 102) to supply, during the image update period (IUk) wherein a particular optical transition of a particular one of the pixels (Pij) is required, an associated one of the drive waveforms (DWk) to the particular one of the pixels (Pij). The associated one of the drive waveforms (DWk) comprises a sequence of a particular number of pulse, (SPk), wherein consecutive ones of the pulses (SPk) of the sequence are separated by a separation period of time (SPT). The particular number of said pulses (SPk), and/or a duration of said pulses (SPk), and/or a duration of the separation period (SPT) of the associated one of the drive waveforms (DWk) is determined to obtain the particular optical transition at a desired energy of the associated one of the drive waveforms (DWk) to decrease an average value of the associated one of the drive waveforms (DWk).

### FIELD OF THE INVENTION

The invention relates to a drive circuit for a bi-stable display, to a method of driving a bi-stable display, and to a display apparatus comprising a bi-stable display and such a drive circuit.

### BACKGROUND OF THE INVENTION

The publication “Drive waveforms for active matrix electrophoretic displays”, by Robert Zhener, Karl Amundson, Ara Knaian, Ben Zion, Mark Johnson, Guofu Zhou, SID2003 digest pages 842-845 discloses that grey scales are obtained in an electrophoretic display by modulating the pulse width and/or amplitude of a single drive pulse in each image update period wherein the image on the matrix display is refreshed.

Generally, the average level of the voltage of the drive waveform for a particular pixel during a sequence of successive image update periods will not be zero. A non-zero average level across a pixel may degrade the pixel.

### SUMMARY OF THE INVENTION

It is an object of the invention to provide a drive circuit for a bi-stable display which decreases the non-zero average level of the voltage of the drive waveforms across the pixels.

To reach this object, a first aspect of the invention provides a drive circuit for a bi-stable display as claimed in claim 1. A second aspect of the invention provides a method of driving a bi-stable display as claimed in claim 13. A third aspect of the invention provides a display apparatus as claimed in claim 14. Advantageous embodiments are defined in the dependent claims.

The drive circuit in accordance with the first aspect of the invention comprises a driver and a controller. The driver supplies drive waveforms to the pixels during an image update period wherein the image presented by the pixels is updated or refreshed. As different pixels may have to undergo different optical transitions, the drive waveforms may differ for different pixels.

The drive waveforms for an electrophoretic display disclosed in the SID2003 publication referred to earlier consist of a single pulse of which the duration and/or the level is controlled to obtain the required optical transition. The not yet published European patent application with application number ID613257, PHNL030524 discloses drive waveforms for an electrophoretic display which comprise during an image update period more than one pulse. The sequence of pulses during an image update period comprises succesively a first shaking pulse, a reset pulse, a second shaking pulse and a drive pulse. The reset pulse has an energy sufficient to obtain one of the two extreme optical states of the electrophoretic display. The drive pulse which succeeds the reset pulse determines the final optical state of the pixel starting from the extreme optical state. This improves the accuracy of the intermediate optical states. The intermediate optical states show grey scales if the extreme optical states show white and black. For example, if an Eink display is used, the particles are usually white and black. The optional shaking pulses have an energy which is large enough to change the optical state of the electrophoretic display but insufficient to move the pixels from one of the extreme optical states to the other. The shaking pulses increase the mobility of the particles in the electrophoretic display and thus improve the reaction of the particles on the succeeding pulse. The drive waveforms may comprise a single shaking pulse per image update period only.

The drive circuit in accordance with the first aspect of the invention divides the single pulse disclosed in the SID publication referred to earlier in a sequence of a particular number of pulses further referred to as sub-pulses. Alternatively, the drive circuit in accordance with the first aspect of the invention divides the reset pulse and/or the grey level drive pulse disclosed in the not yet published patent application ID613257, PHNL030524 in a sequence of a particular number of pulses further referred to as sub-pulses. Consecutive ones of the sub-pulses of the sequence are separated by a separation period of time. If more than two sub-pulses are used, and thus more than one separation period is present, the duration of the separation periods may be different. Because the separation periods should separate the successive sub-pulses, their duration must not be zero. The particular number of sub-pulses, and/or the duration of the sub-pulses, and/or the duration of the separation period(s) of a drive waveform during an image update period is selected or controlled to obtain a desired energy of the drive waveform. The energy of the drive waveform is defined as the integration of the energy of the pulses of the drive waveform. The energy of the pulses is defined as the multiplication of their voltage level and duration.

The possibility to replace a particular single pulse by a series of sub-pulses separated by separation periods allows reaching a same optical transition with a different energy of the drive waveform. Also the number of sub-pulses, their duration and their distance can be influenced to obtain a same optical transition with a different energy of the drive waveform. This flexibility in varying the energy of the drive waveform while still obtaining the same optical transitions can be used for example to minimize the average energy of a drive waveform supplied to a particular pixel for a single transition, or in a drive waveform for a sequence of transitions.

The average energy of the drive waveform is also referred to as the average value of the voltage of the drive waveform, or as the average value of the drive waveform, or as the average value.

In an embodiment in accordance with the invention as claimed in claim 2, the particular number of sub-pulses, and/or the duration of the sub-pulses, and/or the duration of the separation period(s) of a drive waveform during an image update period is selected or controlled to minimize the average value of the voltage of the drive waveform. Preferably, each drive waveform for each one of the pixels is selected or controlled to minimize the average voltage value across each one of the pixels. The average value of the drive waveform is determined during a number of consecutive image update periods if the single pulse is sub-divided. Alternatively, the average value of the drive waveform is determined during a single image update period or a number of consecutive image update periods if the drive waveform comprises a reset pulse and a drive pulse.

The drive circuit is able to obtain an average value of the voltage across a particular pixel which is nearer to zero while the same sequence of optical states is displayed. Usually, bi-stable displays, in particular electrophoretic displays show a non-linear behavior of the variation of the optical state versus the duration a voltage pulse is applied. A short pulse will cause a relatively small change of the optical state because the particles have initially a slow speed. During a longer pulse, the speed of the particles will gradually increase and thus the change in the optical state progressively increases and thus is relatively large. Consequently, a series of short pulses, each consecutive pair of pulses being separated by a separation period, will cause a smaller change of the optical state than a single pulse which has the same duration as the sum of the durations of the short pulses of the series. Or said in another way, it is possible to reach the same optical state transition with a series of short pulses which together have a duration which is larger than the duration of a single pulse. Thus, if, for a particular series of optical transitions occurring during a series of image update periods, the average voltage across a pixel is not zero, it is possible to sub-divide one or more single pulses to obtain an average voltage which is nearer to zero.

When a pulse is sub-divided, the average voltage of the drive waveform of a pixel can be influenced by controlling the number of sub-pulses. If the pulse is sub-divided in more sub-pulses, the duration of each of the sub-pulses is smaller and their effect on the change of the optical state will be smaller. The total duration of many small sub-pulses must be larger than the total duration of only a few relatively long lasting sub-pulses. It is also possible to control the separation period in time. During a relatively long separation period, the speed of the particles will drop significantly, and thus, the influence of the next sub-pulse on the optical state will be smaller than if a relatively small separation period is used.

To conclude, it is possible to obtain the same sequence of optical states of a particular pixel by subdividing a pulse in the drive waveform which otherwise would have been a single pulse into a number of sub-pulses which are separated by a separation period of time. By controlling the number of sub-pulses, and/or duration of the sub-pulses, and/or the duration of the separation period(s) it is possible to influence the average value of the voltage across the pixel while the optical transition caused is the same.

In an embodiment in accordance with the invention as claimed in claim 3, the drive waveforms for all the possible optical transitions of the pixels during an image update period are stored in a memory. The drive waveforms are determined such that in a sequence of optical state transitions the average value of the drive waveform required is lower than when the single pulse is not subdivided into sub-pulses.

To elucidate the operation of this embodiment in accordance with the invention, for example only, it is now assumed that a single drive pulse is used to determine the optical state of the pixel. The drive waveform required to change the optical state of the pixel from a first optical state to a second optical state during a first image update period, and then from the second optical state to the first optical state during a second image update period should have an as low average value as possible. These optical opposite transitions require drive pulses with opposite polarities. The low average value of the drive waveform can be obtained by sub-dividing the pulse with the shortest duration in a series of pulses. The splitting is performed such that the energy of the series of pulses comes closer to the energy of the single pulse while still the required optical transition is reached.

In an embodiment in accordance with the invention as claimed in claim 4, the drive circuit comprises an averaging circuit which keeps track of the average value. The determination of the use of a single pulse or sub-divided pulses depends on the average value determined. If the use of sub-divided pulses would lower the average value it is used during the present image update period, otherwise, the single pulse is used. The characteristics of the sub-divided pulses may be selected to obtain the lowest average value possible.

In an embodiment in accordance with the invention as claimed in claim 5, the invention is applied on the drive waveform which comprises the single pulse disclosed in the SID publication referred to earlier. During particular ones of the image update periods this known drive waveform is used while during other image update periods, this single pulse is replaced by the sequence of the sub-pulses. The image update periods during which the sub-pulses are used, and the number of sub-pulses and/or the duration of the separation periods is controlled to obtain a decreased average voltage value, preferably as close to zero as possible, of the drive waveform.

By way of example, a simple algorithm is to check at the start of an image update period what the value and polarity of the average voltage value is. If the originally single drive pulse for this image update period has the same polarity its duration should be as short as possible to obtain the least possible increase of the average level. Thus the single pulse should be used during this image update period. If the polarity is opposite, it is checked what the polarity would become if the single pulse is used. If the polarity changes, the single pulse is used during this image update period. If the polarity does not change, the single pulse is sub-divided into the sub-pulses. The number of sub-pulses and/or the duration of the separation periods are controlled to obtain an average value as close to zero as possible.

In an embodiment in accordance with the invention as claimed in claim 6, the drive waveform further comprises a shaking pulse which precedes the single pulse and/or the series of sub-pulses which replaces the single pulse. The shaking pulse reduces the dwell time and the influence of the image retention.

In an embodiment in accordance with the invention as claimed in claim 7, the invention is applied on the drive waveform which comprises at least the reset pulse and the single (grey) drive pulse. During particular ones of the image update periods this known drive waveform is used while during other image update periods, this single drive pulse is replaced by a sequence of the sub-pulses. The image update periods during which the sub-pulses are used, and the number of sub-pulses and/or the duration of the separation periods is determined to obtain an average value as close to zero as possible.

If the drive waveforms parts per image update period are stored in a memory, they are predetermined such that in predetermined sequences of optical transitions the average value of the drive waveforms decreases.

The drive waveform parts per image update period may also be determined or selected by using the average value of the drive waveform. By way of example, if the reset pulse has a positive polarity and the drive pulse has a negative polarity, a simple algorithm is to check at the start of an image update period what the value and polarity of the average value is. If this start average value at the start of the image update period is positive and the end average value at the end of the image update period would still be positive if the originally expected drive waveform with the single drive pulse is used, the single drive pulse is replaced by the sub-pulses. If the start average value is positive and the end average value would be negative if the originally expected drive waveform with the single drive pulse is used, the single drive pulse is used. If the start average value is negative and the end average value is still negative if the originally expected drive waveform with the single drive pulse would be used, the single drive pulse is used. If the start average value is negative and the end average value is positive if the originally expected drive waveform with the single drive pulse would be used, the single drive pulse is replaced by the sub-pulses.

In an embodiment in accordance with the invention as claimed in claim 8, the invention is applied to the drive waveform which comprises at least the reset pulse and the single drive pulse. During particular ones of the image update periods this known drive waveform is used while during other image update periods, the single reset pulse is replaced by the sequence of the sub-pulses. The image update periods during which the sub-pulses are used, and the number of sub-pulses and/or the duration of the separation periods is determined to obtain an average value as close to zero as possible.

If the drive waveforms parts per image update period are stored in a memory, they are predetermined such that in predetermined sequences of optical transitions the average value of the drive waveforms decreases.

The drive waveform parts per image update period may also be determined or selected by using the average value of the drive waveform.

By way of example, if the reset pulse has a positive polarity and the drive pulse has a negative polarity, a simple algorithm is to check at the start of an image update period what the value and polarity of the average value is. If the start average value at the start of the image update period is positive and the end average value at the end of the image update period would still be positive if the originally expected drive waveform with the single reset pulse is used, the single reset pulse is not replaced by the sub-pulses. If the start average value is positive and the end average value would be negative if the originally expected drive waveform with the single reset pulse would be used, the single reset pulse is replaced by the sub-pulses. If the start average value is negative and the end average value is still negative if the originally expected drive waveform with the single reset pulse is used, the single reset pulse is replaced by the sub-pulses. If the start average value is negative and the end average value is positive if the originally expected drive waveform with the single reset pulse is used, the single reset pulse is not replaced by the sub-pulses.

In an embodiment in accordance with the invention as claimed in claim 9, a shaking pulse is present preceding the reset pulse. Such a shaking pulse improves the image quality.

In an embodiment in accordance with the invention as claimed in claim 10, a shaking pulse is present in-between the reset pulse and the drive pulse. Such a shaking pulse improves the image quality.

In an embodiment in accordance with the invention as claimed in claim 11, the level supplied to the pixels during the separation periods is selected such that the optical state of the pixels substantially does not change. Usually, the bi-stable display does not change its optical state if the voltage across the pixels is substantially zero.

In an embodiment in accordance with the invention as claimed in claim 12, a braking level is used during the separation period by applying during the separation period a level opposite to the level of the sub-pulse preceding the separation period. Now, in an electrophoretic display, during the separation period, the movement of the particles is decreased rapidly within a short period of time. The particles should start moving again at the next sub-pulse and thus the movement of the particles is minimal during the next sub-pulse. Such a braking level during the separation period may be relevant if the single pulse has to be sub-divided in a large number of sub-pulses which together have a duration which is maximally longer than the duration of the single pulse. However, the braking pulses should have a short duration because they influence the average value across the pixels.

These and other aspects of the invention are apparent from and will be elucidated with reference to the embodiments described hereinafter.

### BRIEF DESCRIPTION OF THE DRAWINGS

In the drawings:

FIG. 1 shows drive waveforms to elucidate embodiments in accordance with the invention wherein a single drive pulse is replaced by a sequence of sub-pulses,

FIG. 2 shows drive waveforms to elucidate embodiments in accordance with the invention wherein a drive waveform is used which comprises a reset pulse and a drive pulse and wherein the reset pulse is replaced by a sequence of sub-pulses,

FIG. 3 shows drive waveforms to elucidate embodiments in accordance with the invention wherein a drive waveform is used which comprises a reset pulse and a drive pulse and wherein the drive pulse is replaced by a sequence of sub-pulses,

FIG. 4 shows that the same change of an the optical state of a pixel can be obtained with a single pulse or a sequence of shorter pulses which together have a duration longer than a duration of the single pulse,

FIG. 5 shows the optical response of an electrophoretic pixel in response to a square voltage pulse,

FIG. 6 shows a state table of optical transitions,

FIG. 7 shows a display apparatus which comprises an active matrix bi-stable display,

FIG. 8 shows diagrammatically a cross-section of a portion of an electrophoretic display, and

FIG. 9 shows diagrammatically a picture display apparatus with an equivalent circuit diagram of a portion of the electrophoretic display.

### DETAILED DESCRIPTION OF THE PREFERRED EMBODIMENT

The indices i, j and k are used to indicate that of a particular item several are present or used. For example the pixel Pij indicates that any one of the pixels may be referred to, or the drive waveform DWk refers to any of the drive waveforms. On the other hand, DW1 refers to a particular one of the drive waveforms DWk.

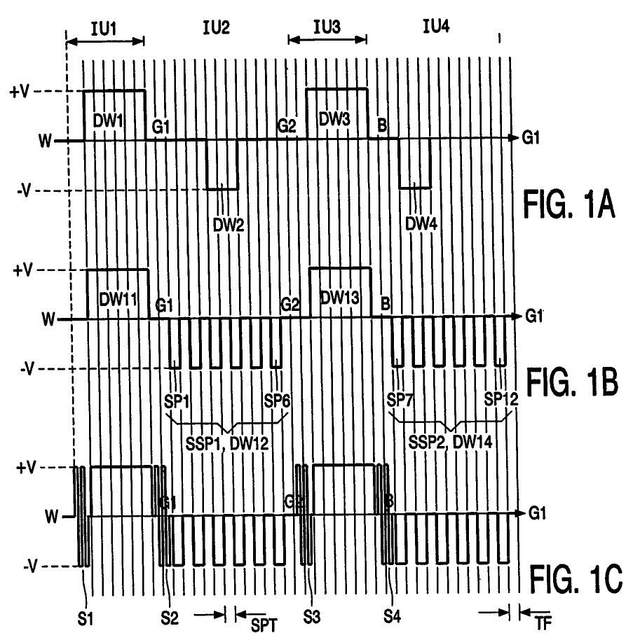

FIG. 1 shows drive waveforms to elucidate embodiments in accordance with the invention wherein a single drive pulse is replaced by a sequence of sub-pulses.

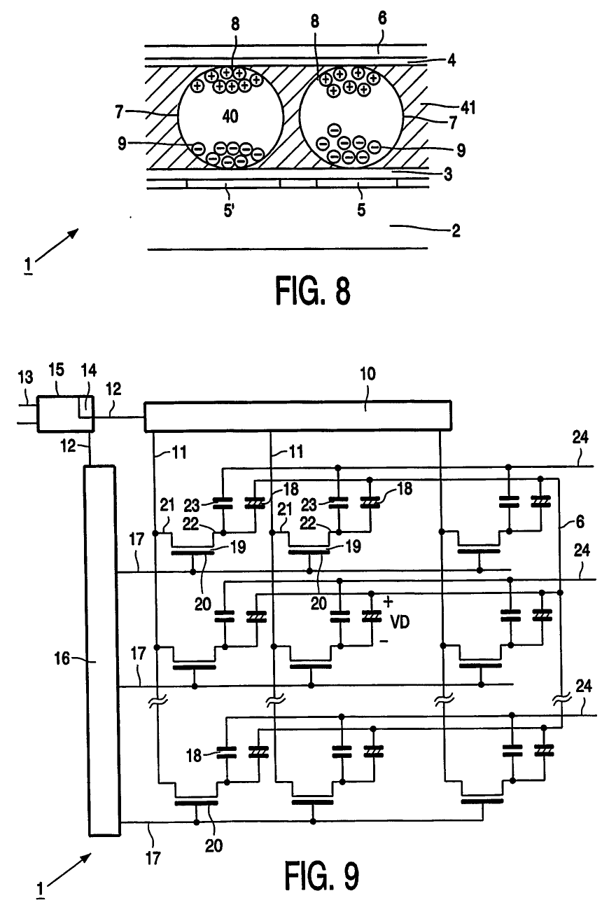

Intermediate levels (for example, grey if black and white particles are used in an EInk type display) in electrophoretic displays are difficult to generate reliably. In general, they are created by applying voltage pulses for specified time periods and thus are determined by the energy of the pulse applied. The intermediate levels are strongly influenced by image distortion, dwell time, temperature, humidity, lateral inhomogeneity of the electrophoretic foils etc. For example, in an EInk type electrophoretic display device which comprises microcapsules with oppositely charged white and black particles, the reflectivity is a function of the particle distribution close to the front of the capsule only, whilst the particle configuration is distributed across the entire capsule. Many configurations will show the same reflectivity. Thus, the reflectivity is not a one to one function of the configuration of the particles. Only the voltage and time response of the particles is truly deterministic, not the reflectivity at a particular instant. The complete image history has to be considered to correctly address an electrophoretic display. A drive method which takes care of the history is called the transition matrix based driving scheme. This method considers up to 6 prior states of a pixel and uses at least 4 frame memories to obtain a reasonable accuracy for direct grey to grey transitions. Usually such a drive method is combined with the single drive pulse disclosed in the SID publication referred to earlier. If a shaking pulse is applied prior to the driving pulse, the number of frame memories can be significantly reduced while still acceptable grey scale accuracy is reached. An embodiment of an EInk type electrophoretic display is described in more detail with respect to FIGS. 8 and 9.

Apparently, it is in both these driving schemes unavoidable that a remnant DC-voltage will occur across the pixels because the pulses used are strictly determined by the optical transitions required. The remnant DC-voltages may become quite large due to integration over a multitude of optical transitions required during successive image update periods for displaying the desired information. This may result in severe image retention and shorten the display lifetime. To provide a robust driving scheme for a bi-stable display, embodiments in accordance with the invention will be explained, for example only, with respect to an active matrix E-ink type electrophoretic display.

FIG. 1A shows a prior art drive waveform across a particular pixel Pij. The drive waveform comprises a sequence of four sub-drive waveforms DW1 to DW4 which occur during four image update periods IU1 to IU4, respectively. The sub-drive waveforms are also referred to as drive waveform. Each of the four drive waveforms DW1 to DW4 comprises a single drive pulse. The drive pulses have a fixed amplitude and their duration is controlled to realize the desired optical transitions. To obtain accurate intermediate levels, the transition matrix based driving scheme is used. FIG. 1A shows the pulses required for four consecutive optical transitions: first from white W to dark grey G1, then to light grey G2, then to black B, and finally to dark grey G1. It is obvious that after these four image transitions, a remnant DC-voltage and thus a remnant DC-energy equal to six times the voltage level V of the pulses multiplied by the frame period TF is present across the particular pixel Pij.

FIG. 1B shows a sequence of four sub-drive waveforms DW11 to DW14 which occur during the four consecutive image update periods IU1 to IU4, respectively. The drive waveforms DW11 and DW13 are identical to the drive waveforms DW1 and DW3 of FIG. 1A and cause identical optical transitions. The drive waveforms DW12 and DW14 now comprise a series of sub-pulses SSP1, SSP2. The sub-pulses SSP1, SSP2 are separated by separation time periods SPT. The separation periods SPT are all equal to the frame period TF. However, the separation periods SPT may have another duration and/or with respect to each other different durations.

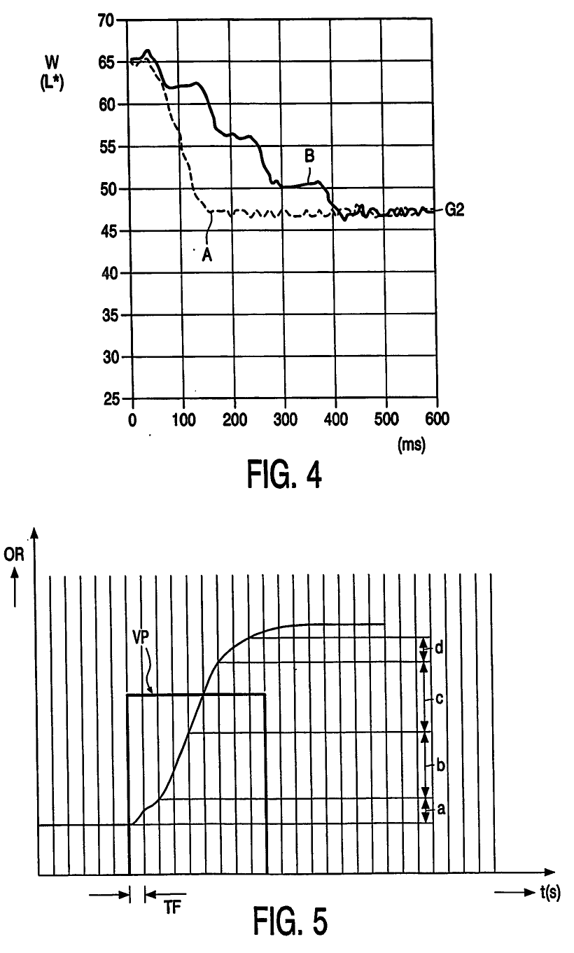

In this embodiment in accordance with the invention, an improved driving scheme is obtained. Both the relative short single pulse DW2 for the transition from dark grey G1 to light grey G2, and the relative short single pulse DW4 for the transition from black B to dark grey G1 now consist of a series of multiple short pulses SSP1 and SSP2, respectively. The series of pulses SSP1 and SSP2 have an energy which is larger than the energy of the single pulses DW2 and DW4, respectively. It is assumed that the remnant DC-energy across the pixel Pij is zero before the single pulse DW1 is applied. After the image update period IU1, due to the drive waveform DW11 which comprises a single positive voltage pulse lasting 6 frame periods TF, the remnant DC energy is 6×V×TF, wherein V is the voltage level of the pulses, and TF is the frame period. Preferably, this remnant DC-energy is reduced as much as possible during the next image update period IU2. If the single drive pulse DW2 of FIG. 1A is applied, the average energy across the pixel Pij decreases with 3×V×TF to 3×V×TF. If the series of pulses SSP1 is applied, the average energy across the pixel Pi j decreases with 6×V×TF to zero because the series of pulses SSP1 comprises 6 pulses SP1 to SP6 each lasting one frame period TF. The total stress across the pixel Pij is zero, while identical optical transition occurs. That the same optical transition from dark grey G1 to light grey G2 is reached with the 6 pulses SP1 to SP6 and with the single pulse DW2, is due to the fact that the optical response of the electronic ink material as a function of the electric field is not linear with the time during which this electric field is applied. This is elucidated in more detail with respect to FIGS. 4 and 5.

During the subsequent optical transition from light grey G2 to black B during the image update period IU3 the drive waveform DW3 consists of a single pulse which may be identical to the single pulse applied during the image update period IU1. The remnant energy across the pixel Pij caused during the image update period IU3 is compensated during the image update period IU4 by replacing the single pulse of the drive waveform DW4 by the series SSP2 of 6 pulses SP7 to SP12, in the same manner as in the image update period IU2.

FIG. 1C shows a sequence of four sub-drive waveforms which is derived from the sequence shown in FIG. 1B by adding shaking pulses S1 to S4 at the start of the image update periods IU1 to IU4. The shaking pulses or pre-pulses S1 to S4 are disclosed in the not yet published European patent application PHNLO20441. The addition of the shaking pulses S1 to S4 reduces the dwell time dependence and the influence of the image history. The grey scale accuracy is improved further, and the image retention is minimized. Also, the number of previous states to be considered may be reduced.

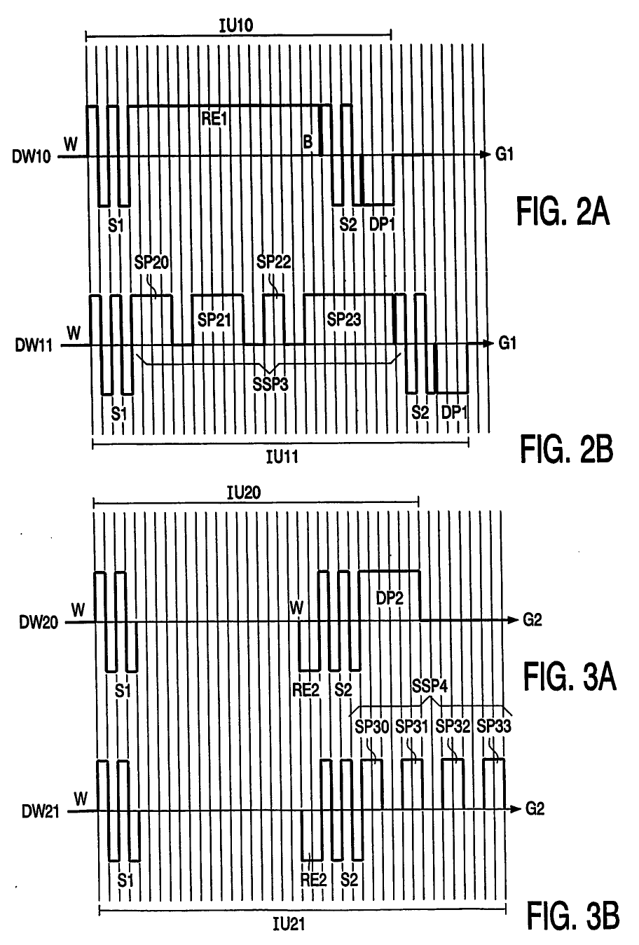

FIG. 2 shows drive waveforms to elucidate embodiments in accordance with the invention wherein a drive waveform is used which comprises a reset pulse and a drive pulse and wherein the reset pulse is replaced by a sequence of sub-pulses.

FIG. 2A shows a drive waveform DW10 occurring during an image update period IU10 and suitable for rail stabilized driving schemes wherein a reset pulse RE1 is used to bring the pixel Pij into one of two well defined extreme optical states (which are white and black if in an electrophoretic display white and black particles are used) and then a driving pulse DP1 which changes the extreme optical state into the desired intermediate optical state which may be in-between the two extreme optical states. This rail stabilized driving scheme is disclosed in the not yet published European patent application PHNLO30091. The reset pulse RE1 has an energy which moves the particles of the electrophoretic display to one of the two extreme optical states, and the grey scale driving pulse moves the particles such that the pixel Pij reaches the desired final optical state. In the example shown in FIG. 2A, an image transition from white W to dark grey G1 via black B is illustrated. A prolonged positive voltage pulse RE1 is applied to set the pixel Pij from the initial white W state to the intermediate black B state. A negative voltage pulse DP1 is supplied to set the pixel Pij to the final desired dark grey state G1. A first shaking pulse S1 precedes the reset pulse RE1 and a second shaking pulse S2 occurs in-between the reset pulse RE1 and the grey scale drive pulse DP1. The shaking pulses S1 and S2 reduce the dwell time dependency and the image retention. The shaking pulses S1 and S2 may comprise several pulses as shown, but also may comprise a single pulse.

FIG. 2B shows a drive waveform DW11 occurring during an image update period IU11 and suitable for rail stabilized driving schemes. The drive waveform DW11 is derived from the drive waveform DW10 by replacing the single reset pulse RE1 with a series SSP3 of reset pulses SP20 to SP23. Again, this series SSP3 of reset pulses SP20 to SP23 is selected to obtain the same optical transition as with the single reset pulse RE1, while the energy content of the series pulses SSP3 is larger than the energy content of the single reset pulse RE1. This difference in energy content may be used to obtain in a sequence of image update periods IUk an average energy across the pixel Pij which is as near as possible to zero.

FIG. 3 shows drive waveforms to elucidate embodiments in accordance with the invention wherein a drive waveform is used which comprises a reset pulse and a drive pulse and wherein the drive pulse is replaced by a sequence of sub-pulses.

FIG. 3A shows a drive waveform DW20 occurring during an image update period IU20 and suitable for the same rail stabilized driving scheme as shown in FIG. 2A but for a different optical transition from white W to light grey G2 instead of to dark grey G1. The drive waveform DW20 comprises successively: a shaking pulse S1, a reset pulse RE2, a shaking pulse S2 and a drive pulse DP2. The negative voltage pulse RE2 is applied to obtain a firm white W state. The positive voltage pulse DP2 is supplied to set the pixel Pij to the desired final light grey state G2.

FIG. 3B shows a drive waveform DW21 occurring during an image update period IU21 and suitable for rail stabilized driving schemes. The drive waveform DW21 is derived from the drive waveform DW20 by replacing the single drive pulse DP2 by a series SSP4 of drive pulses SP30 to SP33. Again, this series SSP4 of drive pulses SP30 to SP33 is selected to obtain the same optical transition as with the single drive pulse DP2 while the energy content of the series pulses SSP4 is larger than the energy content of the single drive pulse DP2. This difference in energy content is used to obtain in a sequence of image update periods IUk an average energy across the pixel Pij which is as near as possible to zero.

FIG. 4 shows that the same change of the optical state of a pixel can be obtained with a single pulse or a sequence of shorter pulses which together have a duration longer than a duration of the single pulse. FIG. 4 shows representative experimental results of the optical transition caused by the drive waveform DW20 of FIG. 3A as the waveform A, and of the optical transition caused by the drive waveform DW21 of FIG. 3B as the waveform B. The optical state L* as function of the time t in milliseconds is shown for an optical transition from white W to light grey G2. It is clearly shown that starting from substantially the same white W optical state a substantially the same light grey G2 optical state is achieved by both the drive waveforms DW20 and DW21. However, the total energy involved in the single grey drive pulse DP2 is 6×V×TF while the energy in the sub-divided grey drive pulse SSP4 is 8×V×TF. It is thus possible to influence the average energy occurring across a pixel Pij during a sequence of image update periods IUk while the same optical transitions are obtained.

FIG. 5 shows the optical response of an electrophoretic pixel in response to a square voltage pulse. In this example, the voltage pulse VP has a duration of 9 frame periods TF. The optical response OR in the first two frame periods TF of the pulse VP is represented by a, the response during the subsequent two frame periods TF of the pulse VP is represented by b, the optical response in the next two frame periods TF of the pulse VP is represented by c, the optical response in the last two frame periods TF of the pulse VP is represented by d. Although the time period always lasts two frame periods TF, the optical responses a, b, c, d are largely different. This is due to the fact that the optical response of the particles to the duration the external electric field applied is not linear in electrophoretic display materials. This non-linearity is used in the embodiments in accordance with the invention for balancing the remnant DC-energy on the pixel Pij, or on the complete display.

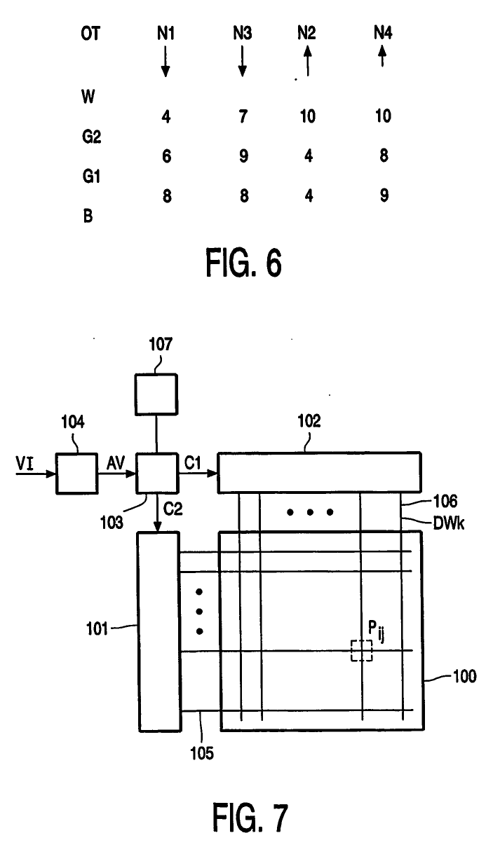

FIG. 6 shows a state table of optical transitions. By way of example, FIG. 6 is based on a drive scheme wherein during each image update period IUk only a drive pulse DPk is used, and wherein four optical states are possible. Thus, the image update periods IUk do not contain reset pulses Rek. This drive pulse DPk may be the well known single pulse, or the series of sub-pulses in accordance with an embodiment of the invention. If the series of sub-pulse is used instead of a single pulse, this series is selected to obtain the same optical transition and to obtain an energy which differs from the single pulse.

The column OT shows the four optical states: white W, light grey G2, dark grey G1 and black B.

The column N1 shows the duration of the drive pulse in frame periods TF for transitions of the optical states shown in the column OT. The downwards pointing arrow indicates that the transitions are from lighter states to darker states. The transition from white W to light grey G2 requires a single undivided drive pulse lasting 4 frame periods TF. The transition from light grey G2 to dark grey G1 requires a single undivided drive pulse lasting 6 frame periods TF. The transition from dark grey G1 to black B requires a single undivided drive pulse lasting 8 frame periods TF.

The column N2 shows the duration of the drive pulse in frame periods TF for transitions of the optical states shown in the column OT. The upwards pointing arrow indicates that the transitions are from darker states to lighter states. The transition from black B to dark grey G1 requires a single undivided drive pulse lasting 4 frame periods TF. The transition from dark grey G1 to light grey G2 requires a single undivided drive pulse lasting 4 frame periods TF. The transition from light grey G2 to white W requires a single undivided drive pulse lasting 10 frame periods TF.

It has to be noted that the electrophoretic pixels 18 need not act symmetrically. To change the optical state from dark grey G1 to black B, the drive pulse should last 8 frame periods TF. The drive pulse required for the opposite transition from black B to dark grey G1 lasts 4 frame periods TF only. Drive pulses DPk for opposite transitions have opposite polarities. The consequence is that for an image transition from dark grey G1 to black B to dark grey G1 the energy of the drive pulse DPk for the transition from dark grey G1 to black B is twice the energy of the drive pulse DPk for the transition from black B to dark grey G1. The average value of the energy of the drive waveform DWk of the sequence dark grey G1 to black B to dark grey G1 is relatively high. The same is true, for example, for the sequence light grey G2 to black B to light grey G2.

To decrease the average energy in such closed-loop sequences, some of the drive pulses DPk are sub-divided in a number of sub-pulses SPk. The number of sub-pulses SPk is selected to obtain the same optical transition as with the corresponding single pulse but which a higher energy of the corresponding drive waveform DWk.

The column N3 shows the adapted duration of the drive pulses for transitions from lighter states to darker states, the column N4 shows the adapted durations of the drive pulses for transitions from darker states to lighter states.

The column N3 shows the duration of the drive pulse in frame periods TF for transitions of the optical states shown in the column OT. The downwards pointing arrow indicates that the transitions are from lighter states to darker states. The transition from white W to light grey G2 is obtained by a sub-divided drive pulse SPk lasting 7 instead of the 4 frame periods TF of the single drive pulse. The transition from light grey G2 to dark grey G1 is obtained by a sub-divided drive pulse SPk lasting 9 instead of the 6 frame periods TF of the single drive pulse. The transition from dark grey G1 to black B is still obtained by using the single drive pulse lasting 8 frame periods TF.

The column N4 shows the duration of the drive pulse in frame periods TF for transitions of the optical states shown in the column OT. The upwards pointing arrow indicates that the transitions are from darker states to lighter states. The transition from black B to dark grey G1 is obtained by using a sub-divided drive pulse SPk lasting 9 instead of the 4 frame periods TF of the single drive pules. The transition from dark grey G1 to light grey G2 requires a sub-divided drive pulse SPk lasting 8 instead of the 4 frame periods TF of the single drive pulse. The transition from light grey G2 to white W is still obtained by the single drive pulse lasting 10 frame periods TF.

To change the optical state from dark grey G1 to black B, the single drive pulse should last 8 frame periods TF. The sub-divided drive pulse SPk required for the opposite transition from black B to dark grey G1 now lasts 9 frame periods TF instead of the 4 frame periods TF of the single drive pulse. The consequence is that for an image transition from dark grey G1 to black B to dark grey G1 the energy of the drive pulse DPk for the transition from dark grey G1 to black B is only marginally larger than the energy of the drive pulse DPk for the transition from black B to dark grey G1. While this ratio was two if only single (non sub-divided) drive pulses DPk are used. For the sequence light grey G2 to black B, an image update period IUk is required with a sub-divided drive pulse SPk lasting 9 frame periods TF and an image update period IUk with a single drive pulse lasting 8 frame periods. For the sequence black B to light grey G2, two image updates periods TF are required with sub-divided drive pulses, the first one lasting 9 frame periods TF, the second one lasting 8 frame periods TF. The energy of the drive waveform DWk required for the transition from light grey G2 to black B and the energy of the drive waveform DWk required for the transition from black B to light grey G2 are identical (17×V×TF) but cancel each other because the drive waveforms DWk have opposite polarities.

If is stated that a sub-divided pulse lasts a particular number of frame periods TF, it is meant that the energy of the sub-divided pulse is equal to the energy of a single pulse lasting this particular number of frame periods TF.

FIG. 7 shows a display apparatus which comprises an active matrix bi-stable display. The display apparatus comprises a bi-stable matrix display 100. The matrix display comprises a matrix of pixels Pij associated with intersections of select electrodes 105 and data electrodes 106. The active elements which are associated with the intersections are not shown. A select driver 101 supplies select voltages to the select electrodes 105, a data driver 102 supplies data voltages to the data electrodes 106. The select driver 101 and the data driver 102 are controlled by the controller 103 which supplies control signals C1 to the data driver 102 and control signals C2 to the select driver 101.

Usually, the controller 103 controls the select driver 101 to select the rows of pixels Pij one by one, and the data driver 102 to supply drive waveforms DWk via the data electrodes 106 to the selected row of pixels Pij. Without the implementation of the sub-divided pulses SPk in accordance with the embodiments of the invention, for example, the drive waveforms of FIG. 1A, FIG. 2A or FIG. 3A are supplied to the pixels Pij. If the sub-divided pulses SPk are required to be supplied to a pixel SPij, for example, one of the drive waveforms of FIG. 1B, FIG. 1C, FIG. 2B or FIG. 3B is supplied to the pixel Pij. The drive waveforms DWk with the single pulse and with the sub-divided pulses SPk may be stored in a table look up table.

Whether for a particular optical transition sub-divided pulses are used or not, and what the characteristics of the sub-divided pulse SPk are, may be predetermined. Thus if, during a particular image update period IUk, a particular optical transition is required the pre-stored drive waveform is retrieved from a memory. This predetermined stored drive waveform comprises either an undivided pulse or the sub-divided pulses SPk, as predetermined to be best suitable for the particular optical transition. The characteristics of the sub-divided pulses SPk may be the number of pulses, the duration of the pulses, the duration of the separation periods.

Alternatively, whether for a particular optical transition sub-divided pulses are used or not, can be determined based on the actual average value of the drive waveform across the pixels Pij sofar. Now, the controller 103 receives an average value AV from the circuit 104 which determines the average value AV based on the information VI to be displayed. The controller 103 checks before the start of a particular image update period IUk the average value AV. Then the controller 103 determines whether the single pulse or sub-divided pulses SPk should be used during the particular image update period IUk. This determination is performed to obtain the required optical transition and an average value AV after this particular image update period IUk which is closest to zero. The control circuit 103 may control the number and/or duration of the splitted pulses SPk, and/or the duration of the separation periods SPT such that a same optical transition is reached as with the single pulse while the average value AV is as close as possible to zero.

By way of example, a simple algorithm is to check at the start of an image update period IUk what the value and polarity of the average value AV is. If the original single drive pulse for this image update period IUk has the same polarity, its duration should be as short as possible to obtain the least possible increase of the average level AV. Thus the single pulse should be used during this image update period IUk. If the polarity is opposite, it is checked what the polarity would become if the single pulse is used. If the polarity changes, the single pulse is used during this image update period IUk. If the polarity does not change, the single pulse is sub-divided into the sub-pulses SPk. The number of sub-pulses SPk and/or the duration of the separation periods SPT is/are controlled to obtain an average value AV as close to zero as possible.

FIG. 8 shows diagrammatically a cross-section of a portion of an electrophoretic display, which for example, to increase clarity, has the size of a few display elements only. The electrophoretic display comprises a base substrate 2, an electrophoretic film with an electronic ink which is present between two transparent substrates 3 and 4 which, for example, are of polyethylene. One of the substrates 3 is provided with transparent pixel electrodes 5, 5′ and the other substrate 4 with a transparent counter electrode 6. The counter electrode 6 may also be segmented. The electronic ink comprises multiple microcapsules 7 of about 10 to 50 microns. Each microcapsule 7 comprises positively charged white particles 8 and negatively charged black particles 9 suspended in a fluid 40. The dashed material 41 is a polymer binder. The layer 3 is not necessary, or could be a glue layer. When the pixel voltage VD across the pixel 18 (see FIG. 2) is supplied as a positive drive voltage Vdr (see, for example, FIG. 3) to the pixel electrodes 5, 5′ with respect to the counter electrode 6, an electric field is generated which moves the white particles 8 to the side of the microcapsule 7 directed to the counter electrode 6 and the display element will appear white to a viewer. Simultaneously, the black particles 9 move to the opposite side of the microcapsule 7 where they are hidden from the viewer. By applying a negative drive voltage Vdr between the pixel electrodes 5, 5′ and the counter electrode 6, the black particles 9 move to the side of the microcapsule 7 directed to the counter electrode 6, and the display element will appear dark to a viewer (not shown). When the electric field is removed, the particles 8,9 remain in the acquired state and the display exhibits a bi-stable character and consumes substantially no power. Electrophoretic media are known per se from e.g. U.S. Pat. No. 5,961,804, U.S. Pat. No. 6,1120,839 and U.S. Pat. No. 6,130,774 and may be obtained from EInk Corporation.

FIG. 9 shows diagrammatically a picture display apparatus with an equivalent circuit diagram of a portion of the electrophoretic display. The picture display device 1 comprises an electrophoretic film laminated on the base substrate 2 provided with active switching elements 19, a row driver 16 and a column driver 10. Preferably, the counter electrode 6 is provided on the film comprising the encapsulated electrophoretic ink, but, the counter electrode 6 could be alternatively provided on a base substrate if a display operates based on using in-plane electric fields. Usually, the active switching elements 19 are thin-film transistors TFT. The display device 1 comprises a matrix of display elements associated with intersections of row or select electrodes 17 and column or data electrodes 11. The row driver 16 consecutively selects the row electrodes 17, while the column driver 10 provides data signals in parallel to the column electrodes 11 to the pixels associated with the selected row electrode 17. Preferably, a processor 15 firstly processes incoming data 13 into the data signals to be supplied by the column electrodes 11.

The drive lines 12 carry signals which control the mutual synchronisation between the column driver 10 and the row driver 16.

The row driver 16 supplies an appropriate select pulse to the gates of the TFT's 19 which are connected to the particular row electrode 17 to obtain a low impedance main current path of the associated TFT's 19. The gates of the TFT's 19 which are connected to the other row electrodes 17 receive a voltage such that their main current paths have a high impedance. The low impedance between the source electrodes 21 and the drain electrodes of the TFT's allows the data voltages present at the column electrodes 11 to be supplied to the drain electrodes which are connected to the pixel electrodes 22 of the pixels 18. In this manner, a data signal present at the column electrode 11 is transferred to the pixel electrode 22 of the pixel or display element 18 coupled to the drain electrode of the TFT if the TFT is selected by an appropriate level on its gate. In the embodiment shown, the display device of FIG. 1 also comprises an additional capacitor 23 at the location of each display element 18. This additional capacitor 23 is connected between the pixel electrode 22 and one or more storage capacitor lines 24. Instead of TFTs, other switching elements can be used, such as diodes, MIMs, etc.

To conclude, in a preferred embodiment in accordance with the invention, the drive circuit for driving a bi-stable display 100 comprises a driver 101, 102 which supplies drive waveforms DWk to the pixels Pij of the display 100 during an image update period lUk wherein the image presented by the pixels Pij is updated. An averaging circuit 104 determines for each one of the pixels Pij an average value AV of the energy of the drive waveform DWk for each pixel Pij during one image update period IUk or during consecutive image update periods IUk. A controller 103 controls the driver to supply to a particular pixel Pij, during a particular one of the image update periods IUk, a drive waveform DWk comprising a particular undivided pulse, and during another one of the image update periods IUk, a drive waveform DWk comprising, instead of the particular undivided pulse, a particular number of pulses separated by the separation period of time SPT as a series of sub-pulses SPk. The controller 103 controls the number of sub-pulses SPk in response to the average value AV to obtain an average value AV which is as close to zero as possible.

In another preferred embodiment, all the drive waveforms which may occur during an image update period are pre-determined and are stored in a memory. The pre-determined drive waveforms are selected to decrease the average energy of a drive waveform in a sequence of image update periods wherein the optical states change starting from a starting state to at least one other optical state and ending again at the starting state. At least one of the selected drive waveforms comprises a series of sub-pulses instead of an undivided pulse. The series of sub-pulses is selected to obtain the same optical transition as with the corresponding undivided pulse, and to obtain a different energy of the drive waveform during this image update period. The different energy is preferably used to obtain an average energy of the complete drive waveform during the sequence of image update periods which is lower than when only the undivided pulses would be used.

It should be noted that the above-mentioned embodiments illustrate rather than limit the invention, and that those skilled in the art will be able to design many alternative embodiments without departing from the scope of the appended claims. For example, although most embodiments in accordance with the invention are described with respect to an electrophoretic E-ink display, the invention is also suitable for electrophoretic displays in general and for bi-stable displays. Usually, an E-ink display comprises white and black particles which allows to obtain the optical states white, black and intermediate grey states. Although only two intermediate grey scales are shown, more intermediate grey scales are possible. If the particles have other colors than white and black, still, the intermediate states may be referred to as grey scales. The bi-stable display is defined as a display that the pixel (Pij) substantially maintains its grey level/brightness after the power/voltage to the pixel has been removed.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A drive circuit for a bi-stable display (100) having pixels (Pij), the drive circuit comprises:
a driver (101, 102) for supplying drive waveforms (DWk) to the pixels (Pij) to obtain during an image update period (IUk) an update of an image presented by the pixels (Pij), and
a controller (103) for controlling the driver (101, 102) to supply, during the image update period (IUk) wherein a particular optical transition of a particular one of the pixels (Pij) is required, an associated one of the drive waveforms (DWk) to the particular one of the pixels (Pij), the associated one of the drive waveforms (DWk) comprising a sequence of a particular number of pulses (SPk), wherein consecutive ones of the pulses (SPk) of the sequence are separated by a separation period of time (SPT), the particular number of said pulses (SPk), and/or a duration of said pulses (SPk), and/or a duration of the separation period (SPT) of the associated one of the drive waveforms (DWk) being determined to obtain the particular optical transition at a desired energy of the associated one of the drive waveforms (DWk).

2. A drive circuit as claimed in claim 1, wherein the controller (103) is arranged for controlling the driver (101, 102) to supply the particular number of said pulses (SPk), and/or a duration of said pulses (SPk), and/or a duration of the separation period (SPT) of the associated one of the drive waveforms (DWk) being determined to decrease an average value of the energy of the associated one of the drive waveforms (DWk)

3. A drive circuit as claimed in claim 1, wherein the drive circuit further comprises a memory (107) for storing the drive waveforms (DWk) required for all possible optical transitions of the pixels (Pij), at least one of the drive waveforms (DWk) comprising the sequence of the particular number of pulses (SPk).

4. A drive circuit as claimed in claim 1, wherein the drive circuit further comprises an averaging circuit (104) for determining, during the image update period (IUk), or during a sequence of image update periods (IUK), for the particular one of the pixels (Pij) an average value (AV) of the energy of the associated one of the drive waveforms (DWk), and wherein the controller (103) is arranged for receiving the average value (AV) to control the particular number of said pulses (SPk), and/or a duration of said pulses (SPk), and/or a duration of the separation period (SPT) of the associated one of the drive waveforms (DWk) in response to the average value (AV) to decrease the average value (AV).

5. A drive circuit as claimed in claim 2, wherein the controller (103) is arranged for controlling for the particular pixel (Pij) the driver (101, 102) to supply the drive waveform (DWk) comprising the particular number of pulses (SP1, . . . SP6) separated by the separation period of time (SPT) as a series of sub-pulses (SSP1) during the image update period (IU2), and to supply a single pulse (DW1) only, during another image update period (IU1), the number of sub-pulses in the series (SSP1) being determined to decrease the average value (AV) of the drive waveform (DWk) during the total period in time covering the image update period (IU2) and the other image update period (IU1).

6. A drive circuit as claimed in claim 5, wherein the controller (103) is arranged for controlling for a particular pixel (Pij) the driver (101, 102) to supply the drive waveform (DWk) further comprising a shaking pulse (S1) preceding the single pulse (DW1) and/or preceding the series of sub-pulses (SSP1).

7. A drive circuit as claimed in claim 2, wherein the controller (103) is arranged for controlling for a particular pixel (Pij) the driver (101, 102) to supply during the image update period (IU21) the drive waveform (DW21) comprising the particular number of pulses (SP30, . . . , SP33) separated by the separation period of time (SPT) as a series of sub-pulses (SSP4), and to supply, during another image update period (IU20), the drive waveform (DW20) comprising a single drive pulse (DP2) instead of the particular number of pulses (SP30, . . . , SP33), and a reset pulse (RE2) preceding the drive pulse (DP2), the number of sub-pulses of the series (SSP4) being determined to decrease the average value (AV) of the drive waveform (DWk) during the total period in time covering the image update period (IU20) and the other image update period (IU10).

8. A drive circuit as claimed in claim 2, wherein the controller (103) is arranged for controlling for a particular pixel (Pij), the driver (101, 102) to supply, during an image update period (IU11), the particular number of pulses (SP20, . . . , SP23) separated by the separation period of time (SPT) as a series of sub-pulses (SSP3) for resetting the particular pixel (Pij) to one of its extreme optical states, and to supply during another image update period (IU10), the drive waveform (DW10) comprising a single reset pulse (RE1) instead of the series of sub-pulses (SSP3), and a drive pulse (DP1) succeeding the single reset pulse (RE1), the number of sub-pulses of the series (SSP3) being determined to decrease the average value (AV) of the energy of the drive waveform (DWk) during the total period in time covering the image update period (IU11) and the other image update period (IU10).

9. A drive circuit as claimed in claim 7, wherein the controller (103) is arranged for controlling the driver (101, 102) to supply during both the image update period (IUk) and the another image update period (IUk) a first shaking pulse (S1) preceding said reset pulse (RE1; RE2).

10. A drive circuit as claimed in claim 7, wherein the controller (103) is arranged for controlling the driver (101, 102) to supply during both the image update period (IUk) and the another image update period (IUk) a second shaking pulse (S2) occurring between said reset pulse (RE1; RE2) and the drive pulse (DP1; DP2).

11. A drive circuit as claimed in claim 1, wherein the controller (103) is arranged for controlling the driver (101, 102) to supply a level during the separation period of time (SPT) to substantially keep an optical state of the particular one of the pixels (Pij) unaltered.

12. A drive circuit as claimed in claim 1, wherein the controller (103) is arranged for controlling the driver (101, 102) to supply during the separation period (SPT) a level opposite to the level of the one of the pulses (SPk) preceding the separation period (SPT).

13. A method of driving a bi-stable display (100) having pixels (Pij), the method comprises:
supplying (101, 102) drive waveforms (DWk) to the pixels (Pij) to obtain during an image update period (IUk) an update of an image presented by the pixels (Pij), and
controlling (103) the driver (101, 102) to supply, during the image update period (IUk) wherein a particular optical transition of a particular one of the pixels (Pij) is required, an associated one of the drive waveforms (DWk) comprising a sequence of a particular number of pulses (SPk), wherein consecutive ones of the pulses (SPk) of the sequence are separated by a separation period of time (SPT), the particular number of said pulses (SPk), and/or a duration of said pulses (SPk), and/or a duration of the separation period (SPT) of the associated one of the drive waveforms (DWk) being determined to obtain the particular optical transition at a desired energy of the drive waveform (DWk) during the image update period (IUk).

14. A display apparatus comprising a bi-stable display (100) and a drive circuit as claimed in claim 1.

15. A display apparatus as claimed in claim 14, wherein the bi-stable display (100) is an electrophoretic display (1).
